(19) United States
(12) Patent Application Publication
(10) Pub. No.: US 2005/0125838 A1
(43) Pub. Date: Jun. 9, 2005

(54) Control mechanisms for enhanced features for streaming video on demand systems

(76) Inventors: Meng Wang, Richmond (CA); Jian Wang, Burnaby (CA); Ying Luo, Mississauga (CA); Ignatius Cheng, Burnaby (CA)

Correspondence Address: William R. Coenen, III;Kean, Miller, Hawthorne, D'Armond,, McCowan & Jarman, L.L.P., P.O. Box 3513, Baton Rouge, LA, 70821, US

(21) Appl. No.: 10/727,857

(22) Filed: Dec. 4, 2003

(51) Int. Cl. H04N 7/173

(52) U.S. Cl. 725/109; 725/110; 725/112; 725/113; 725/86

(57) ABSTRACT

The present invention discloses a method and system for the provision of enhanced features in streamed video on demand (SVOD) over a network.

### FIELD OF THE INVENTION

The present invention relates generally to systems for providing steamed video on demand to end users. More specifically the present invention relates to the provision of enhanced features to viewers of digital video on demand over Internet Protocol (IP) based networks.

### BACKGROUND

Prior art streamed video on demand (SVOD) systems and an growing body of developing international standards exist for the provision of digital video content to end users. Current implementations of these systems are expensive, rely upon proprietary or inaccessible networks or cable systems and creating the net result of systems that do not provide the combination of attractive price, meaningful functionality and dependable delivery over existing networks. The present invention offers an inexpensive, scalable, modular and dependable system that brings meaningful and attractive features to end users.

### BRIEF DESCRIPTION OF THE FIGURES

Table 1 sets out the technical specifications of the present invention.

FIG. 1 illustrates the general structure of present invention.

FIG. 2 is a block diagram of the general structure of present invention.

FIG. 3 is a block diagram of movie production using the present invention.

FIG. 4 is a block diagram of the user account module of the present invention.

FIG. 5 is a block diagram of on-line intelligent retrieval of the present invention.

FIG. 6.1 is a block diagram of the process of streaming movie content to clients in the present invention.

FIG. 6.2 is a block diagram of the data communication between the media server an the client in the present invention.

FIG. 7 is a block diagram of the movie playback and control mechanism of the present invention.

FIG. 8 illustrates a streaming sequence in the present invention.

FIG. 9 illustrates a streaming sequence in the present invention.

FIG. 10 illustrates a streaming sequence in the present invention.

FIG. 11 illustrates a coding strategy in the present invention.

FIG. 12 illustrates a coding strategy in the present invention.

FIG. 13 illustrates a coding strategy in the present invention.

FIG. 14 illustrates a coding strategy in the present invention.

FIG. 15 illustrates a streaming sequence in the present invention.

### DETAILED DESCRIPTION OF THE INVENTION

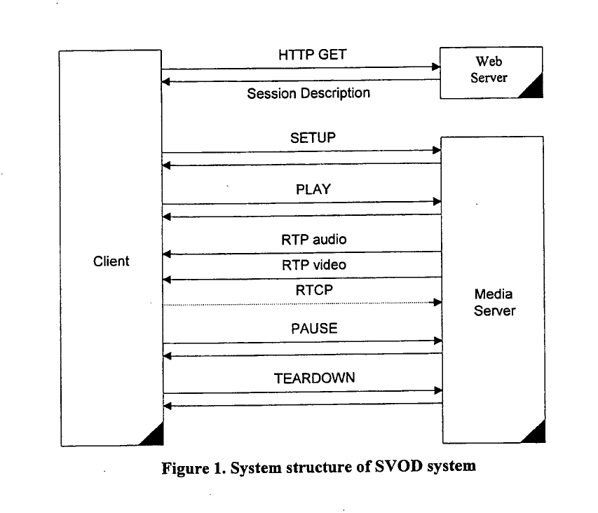

FIG. 1 illustrates the general structure of the present invention. Initially, the end user issues an HTTP GET command to the web server to start a Real Time Streaming Protocol (RTSP) session. The web server, after receiving and processing the connection request will send back to the end user a session description. If the web server agrees to establish the connection, it will start a client player, which will issue a SETUP request to the media server and a connection is established between the client player and the media server. As a result, data communication is ready and the user may choose to play/pause the media subsequently streamed from the media server. Simultaneously, the client player in the present invention may send back some Real-time Transport Control Protocol (RTCP) packets to give quality of service (QoS) feedback and support the synchronization of different media streams that exist in the preferred embodiment of the present invention. It will convey information such as the session participant and multicast-to-unicast translators. At the conclusion of the session or upon user request, the client player will close the connection by sending a TERADOWN command to the media server; the media server will then close the connection.

For the streaming control, the preferred embodiment of the present invention may use the Real Time Streaming Protocol (RTSP). Considering its popularity and quality, it is a good protocol to set up and control media delivery. For the actual data transfer, Internet Engineering Task Force (IETF) authored Real-time Transport Protocol (RTP) may be used. RTP is layered on top of TCP/IP or UDP and is effective for real-time data transmission.

For resources control, Resource ReserVation Protocol (RSVP) may be used to provide the QoS services to end users. When a client sends a request to the web server for a movie with some quality requirements, the server will decide if the resources for the requirements are available or not. If the resources are available, they will be reserved for media transmission from the server to the client; otherwise, the server will notify the client that there are not enough resources to meet its requested requirements.

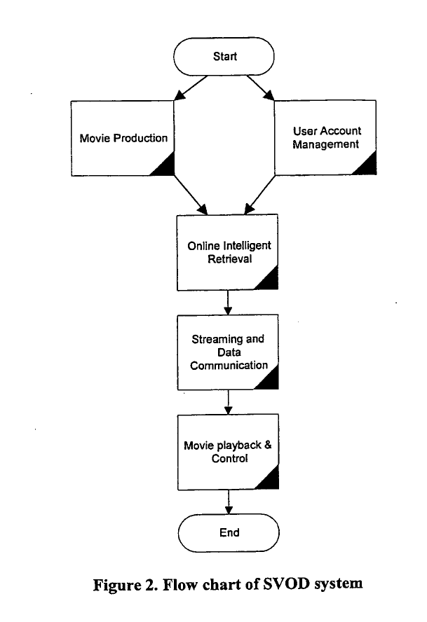

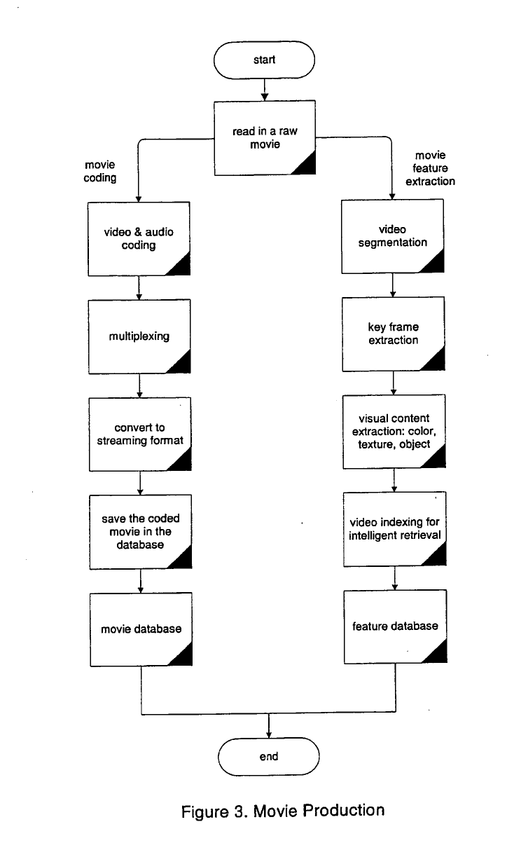

FIG. 2 illustrates the overall flow chart of the streaming video on demand system of the present invention. The system is composed of five modules: movie production, intelligent movie retrieval, movie streaming, movie playback, and user account management processes.

Movie production is the process used to generate a movie database for playback and a feature database for movie retrieval. When new movies come, they will go through two processes. One is encoding process, where the movie content is encoded and converted to a bit-stream suitable for streaming. The other is a preprocessing step, where some semantic contents of the movie are extracted, such as keywords, movie category, scene change information, story units, important objects, and so on.

Another important module is the user account management, which consists of a user registration control and a user account information database. User registration provides an interface for new users to register and existing users to log on. User account information database saves all the user information, including credit card number, user account number, balance, and so on. This information is very important and must be secured against intrusion during both transmission and storage.

After movie encoding production, a movie database is available for customers to browse. However, if the database contains tens of thousands of movies, it is difficult to find a wanted movie. Therefore, a search engine is necessary for the efficiency of the system. The search can be based on movie title, movie features, and/or important objects. Movie title search is quite obvious and can be implemented easily. Movie feature search means searching the feature database to find movies with certain, fundamental features. The features may include color, texture, motion, shape, and so on. A third search criteria may be to find movies with certain important objects, such as featured performers, director or other criteria.

Once an end user selects a movie, the movie streaming and data communication module will be started. Streaming and data communication is a process to open a connection between the client and media server and send the compressed movie file to the client for playback. The file is in a format suitable for streaming. By using streaming, the client can start to play the movie after buffering a certain number of frames, which is much more user friendly than downloading and playing.

The next module is responsible for playing and controlling the movie. Movie playback will be performed while streaming continues. At the same time, another thread will be maintained for the control information from the customer. The control information includes play/stop/pause, fast forward/backward, and exit.

When a user chooses a movie to watch, the web server should activate the corresponding player, which will communicate with the media server for the specific movie. Some configuration is required to enable the web server to recognize appropriate file extensions and call the corresponding player.

The media server is of key importance within the system and its responsibilities include setting up connections with clients, transmitting data, and closing the connections with clients.

All movie files saved in the media server are in streaming format. The data communication between client and media server will use RTSP for control and RTP for actual data transmission. SDKs from Real Network are available to convert files coded for the present invention into the standard streaming format. At the decoder side, the same SDKs can be used to convert the streaming data into a multiplexed bit stream.

Movie production is a procedure to create stream video files. The production process of the present invention includes a video coding and conversion process and a content extraction process. The first process encodes a raw movie and converts the encoded file into a format suitable for streaming. For video coding, the preferred embodiment of the present invention uses H.263+, for audio, MP3. The multiplexing scheme is from available MPEG standards. After encoding and multiplexing, the bit-stream is converted to a streaming format. The present invention may use some Real Producer SDKs to convert the bit-stream to a file in streaming format and the file is saved in a movie database.

The content extraction process starts with video segmentation, where the scene changes are detected and a long movie is cut into small pieces. Within each scene change, one or more key frames are extracted. Key frames can be organized to form a storyboard and can also be clustered into units of semantic meaning, which correspond to some stories in a movie. Visual features of the key frames are computed, such as color, texture, and shape. The motion and object information within each scene change can also be computed. All this information will be saved in a movie feature database for movie database indexing and retrieval.

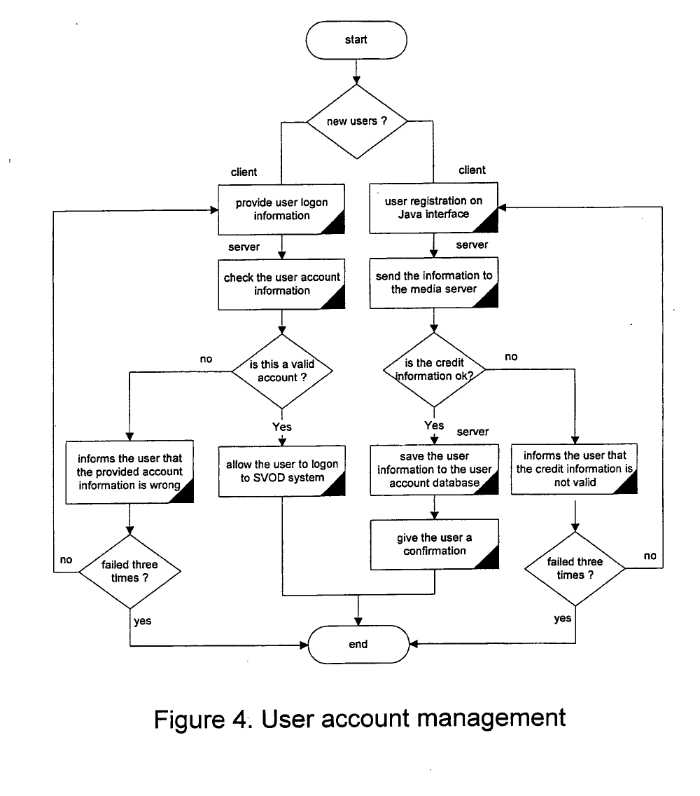

User account management module, as illustrated in FIG. 4 is responsible for user registration and user account information management. User registration is realized via a Java interface, where the new users are required to provide some information and the existing users can just type in the user name and password. For a new user, the new account information needs to be entered and sent to the media server for confirmation. If the account information is ok, then an account name and password will be generated and sent to the user. Otherwise, the user will be asked to reenter the account information. If the user fails three times, the module will exit. For an existing user, a logon interface will appear for the user name and password. If the user name and password are ok, the user is allowed to browse the movie database and choose the movies to watch. Otherwise, the user is informed that the user name and/or password are not correct. The user can reenter the user name and password. If the user fails three times, the module will exit.

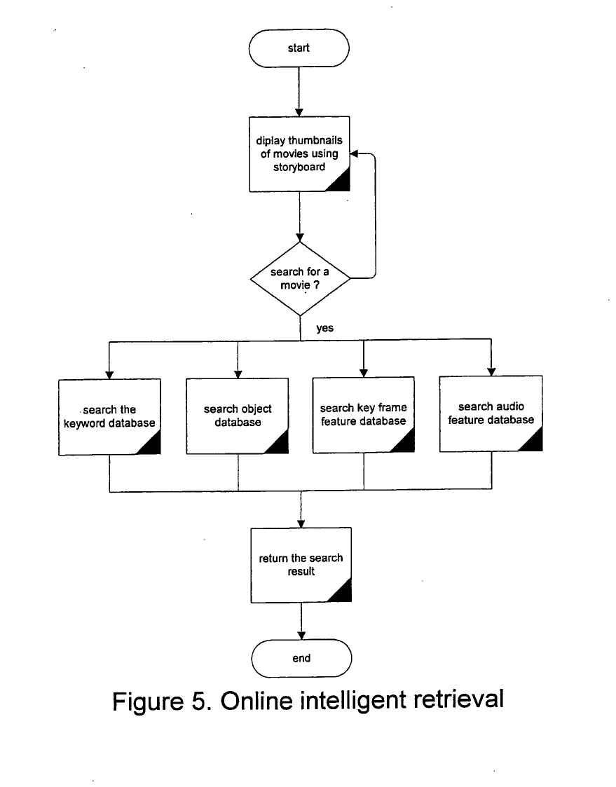

FIG. 5 illustrates the flow chart of online intelligent retrieval module. This module displays the thumbnails of a selected set of movies. If a customer wants to search for a movie, several search criteria are available, such as movie title, keywords, important objects, feature-based search, and audio feature search. A feature database will be searched against the user-specified criteria and the thumbnails of the best matches in the movie database will be returned as the search result. The customer can then browse the thumbnails to get more detailed information or click them to playback a short clip. This module allows users to find a set of movies that they like in a short time.

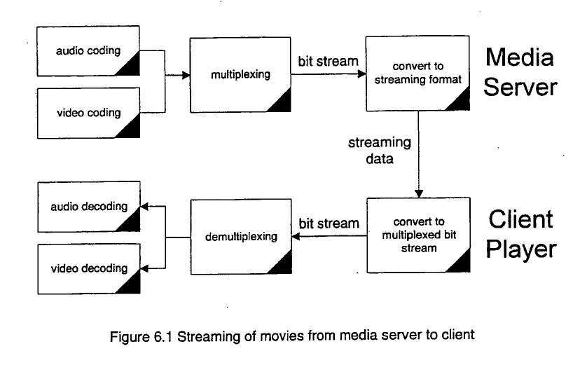

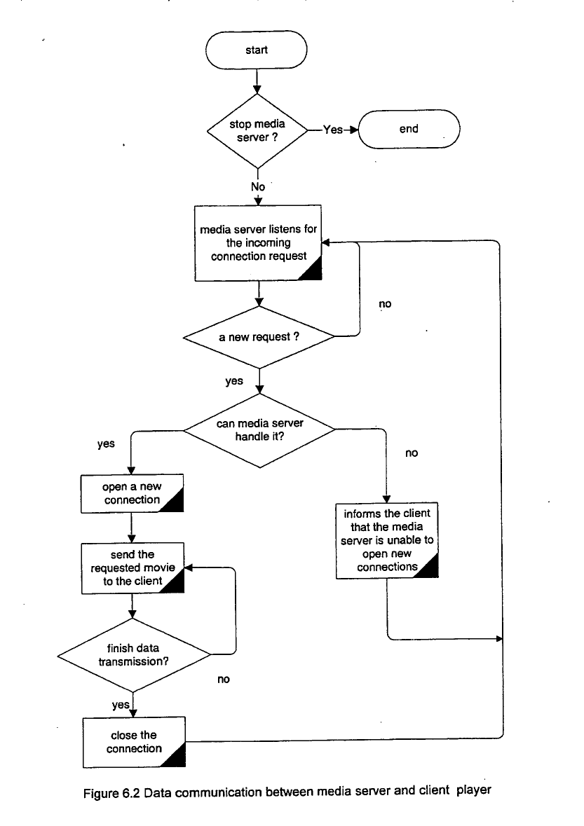

FIG. 6.1 shows the streaming process between the media server and client player. After video and audio coding, multiplexing is applied to generate a multiplexed bit-stream with timing information. Then the bit-stream is converted to the streaming format and sent to the client. When the client receives the bit-stream, it will convert it back to the multiplexed bit-stream, which will be de-multiplexed and sent to audio and video decoder for playback.

FIG. 6.2 shows the data communication between the media server and client player. If the media server does not receive a stop command, it will always check the incoming connection requests from the client players. When a new connection request comes in, the media server will check the available resources to see if it can handle this new request. If so, it will open a new connection and stream the requested movie to the client; otherwise, it will inform the client that the server is unable to process the request. After the movie is streamed to the client, the connection between the media server and the client will be closed so that the network bandwidth can be saved for other uses.

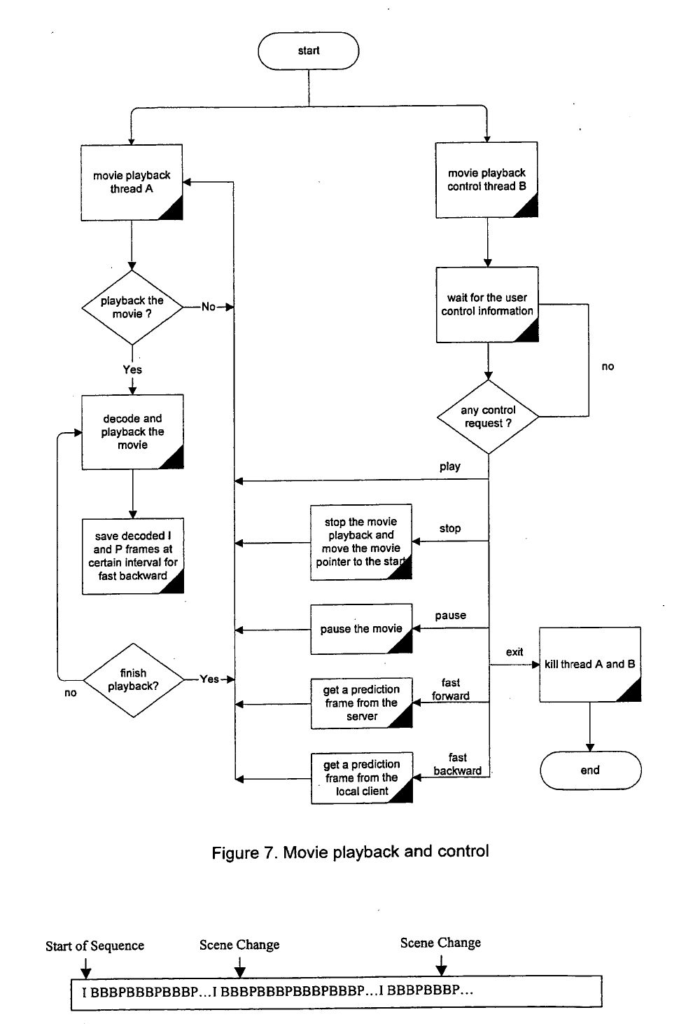

The movie playback and control module as illustrated in FIG. 7. has two threads A and B. Thread A decodes the compressed movie and play it, and thread B accept the control information from the customers. The control information includes play, stop/pause, fast forward/backward, and exit command. Thread checks if the current playback mode is set to on or not. If it is on, then thread A will decode the current movie file and play back the movie; otherwise, it will do nothing. When the decoding and playback continue, some reconstructed P frames will be saved for fast backward function. After finish playback, the playback mode will be set to off. The right side of FIG. 7 shows the work of thread B, which accepts control information from the customers. When a play command is received, it will call play function of thread A and play the movie. When a stop command is received, the current movie will be stopped and the file pointer will be moved to the start of the movie. When a pause command is received, the current movie is paused at the current position. When a fast forward command is received, if the customer wants to fast forward to an I frame, then the information is available in the local disk. However, if the customer wants to fast forward to a P or B frame, then the client player needs to fetch one or two reconstructed frames from the media server. When a fast backward command is received, a reconstructed P frame or an I frame is obtained to start the decoding process. When an exit command is received, thread A and B are killed and client player exits.

Random frame search is the ability of a video player to relocate to a different frame from the current frame. Since the video frames are typically organized in a one-dimensional sequence, random frame search can be classified into fast forward (FF) and fast backward (or rewind REW).

If every frame in a video sequence is independently encoded (I-frame), then the player (decoder) would have no difficulty to jump to an arbitrary frame and resume the decoding and play from there. In a video sequence with all frames as I-frames, every frame can serve as a starting point of a new video sequence in FF and REW functions. However, due to its low compression, very few systems, such as MJPEG, use this scheme.

In MPEG family, predicted frames (P-frame) and bi-directional frames (B-frame) are used to achieve higher compression. Since the P-frames and B-frames are encoded with the information from some other frames in the video sequence, they can not be used as the starting point of a new video sequence in FF and REW functions.

MPEG family supports the FF and REW functions by inserting I-frames at fixed intervals in a video sequence. Upon a FF or REW request, the player will locate to the nearest I-frame prior to the desired frame and resume the playing from there. The following figure shows a typical MPEG video sequence, where the interval between a pair of I-frames is 16 frames:

I BBBPBBBPBBBPBBB I BBBPBBBPBBBPBBB I...

However, I-frames usually have lower compression ratio than P and B frames. MPEG family provides a tradeoff between the compression performance and VCR functionality.

The new method, the DRFS, is realized by keeping two sequences for a given video archive on the media server. One sequence, called streaming sequence, provides the data for normal transmission purpose. Another sequence, the index sequence, provides the data for realizing FF and REW functions.

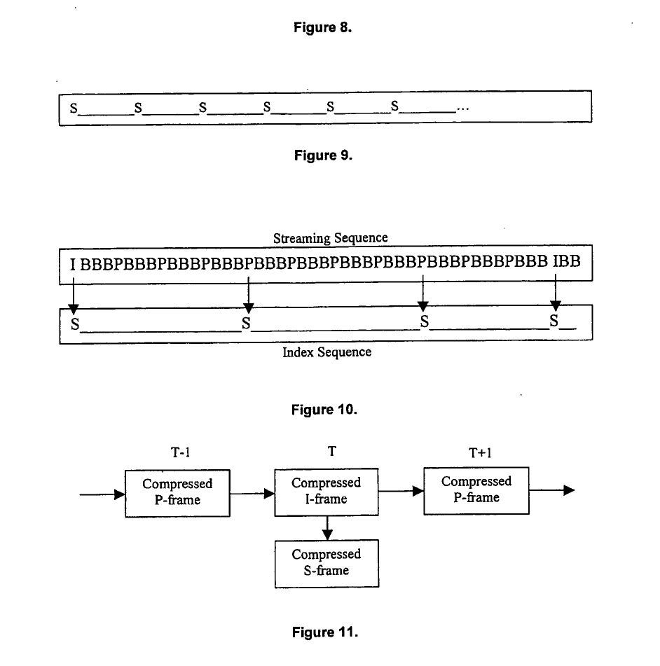

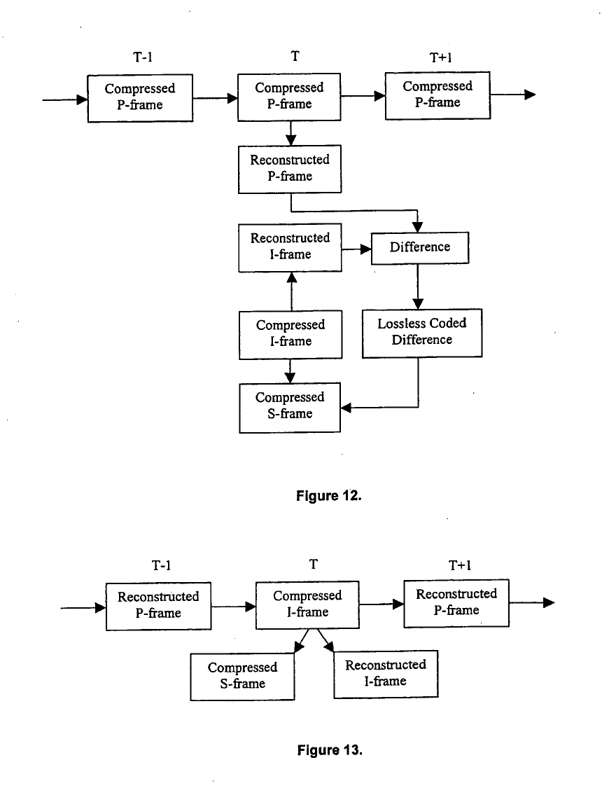

The streaming sequence starts with an I-frame, and contains I-frames only at places where scene changes occur. This is shown in FIG. 8:

The index sequence contains search frames (S-frame) to support the FF and REW functions, as shown in FIG. 9. The interval between a pair of S-frames can be variable, and is determined by the requirement of the accuracy of random search.

During the encoding process, the streaming sequence is coded as the primary sequence, and the index sequence is derived from the streaming sequence. An S-frame in the index sequence can be derived either from an I-frame or from a P-frame of the streaming sequence, but not from a B-frame. This is illustrated in FIG. 10.

The process of deriving an S-frame from an I-frame is trivial as illustrated in FIG. 11. The present invention simply copies the compressed I-frame data into the buffer of the S-frame.

The following diagram shows how an S-frame is derived from a P-frame. Firstly, the reconstructed form of this P-frame is needed, and it can be acquired from the feedback loop of the normal P-frame encoding routine. Secondly, an I-frame encoding routine is called to encode this same frame as an I-frame, and one must keep both its compressed form and its reconstructed form.

Then, the difference between the reconstructed P-frame and the reconstructed I-frame is calculated. This difference is encoded through a lossless process. The lossless-encoded difference, together with the compressed I-frame data, forms the complete set of data of the S-frame.

Similar to the encoding process, the decoder needs to derive an index sequence while decoding the streaming sequence. Same as the encoding process, an S-frame in the index sequence can be derived either from an I-frame or from a P-frame of the streaming sequence, but not from a B-frame. Notice that in theory, the decoder does not necessarily need to produce the S-frames at the same locations in the sequence as the encoding process.

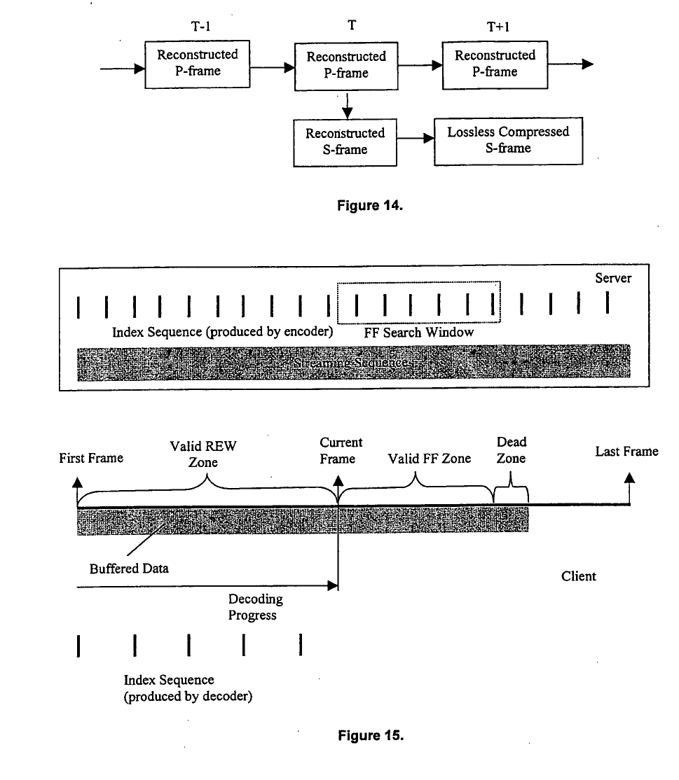

FIG. 13 shows the derivation of an S-frame from I-frame in decoding while FIG. 14 illustrates the derivation of an S-frame from a P-frame.

Notice that the S-frame derived from an I-frame is saved in compressed form, whereas the S-frame derived from a P-frame is saved in reconstructed form. Since the reconstructed form requires much larger storage space than the compressed form does, this system uses two approaches to save the space required by P-frame derived S-frames: (1) use a lossless compression step to save the reconstructed S-frames, which can in average reduce the required space by 50%. (2) Produce a sparser index sequence than the encoding process.

In streaming process, the encoded streaming sequence stored on the media server is transmitted to the client player.

The client player decodes the received streaming sequence, and at the same time produces an index sequence and stores it in a local storage associated with the player.

FIG. 15 illustrates the method by which the FF and REW functions are achieved with the DRFS technology. Suppose the decoding process is currently at the place of ‘Current Frame’. Because this is a streaming application, the current frame is placed somewhere within the buffered data range. In general, this situation defines two searching zones for random frame access. The Valid REW Zone starts with the first frame and ends at the current frame, and the Valid FF zone is from the current frame to the front end of the buffered data range. In practice, the present invention defines a Dean Zone at the front end of the buffered data range for the sake of smooth play after the FF search operation.

When the client player receives a user request for FF operation, it first checks to see if the wanted frame is within the valid FF zone. If yes, the wanted frame number is sent to the media server. The server will locate the S-frame that is nearest to the wanted frame and send the data of this S-frame (compressed) to the client. Once this data is received, the player decodes this S-frame and plays it. The playing process will continue with the data in the buffer.

When a REW request is received by the player, it will first check the local index sequence to see if a ‘close-enough’ S-frame can be found. If yes the nearest S-frame will be used to resume the video sequence. If no, a request is issued to the server to download an S-frame that is nearest to the wanted frame.

In both FF and REW operations, the downloaded S-frame is stored in client's local storage after it is used to resume a new video sequence.

This random search technique is referred to as being ‘distributed’ because both the server and the client provide partial data for the index sequence. Given a specific FF or REW request, the wanted S-frame could be found either in the local index sequence or in the server's index sequence. At the end of the play process, the user will have a complete set of S-frames for later review purposes. Therefore, when the viewer watch the same video content for the second time, all FF and REW functions will be available locally.

A storyboard is a short—usually 2 or 3 minute—summary of a movie, which shows the important pictures of a feature length movie. People usually want to get a general idea of a movie before ordering. The SVOD system allows the viewers to preview the storyboard of a movie to decide whether to order it or not. Another advantage of the storyboard is to allow viewers to fast forward/backward by storyboard unit instead of frame by frame. Moreover, some indexing can be utilized based on the storyboard and intelligent retrieval of movies can be realized.

The generation of a storyboard involves three steps. First of all, some scene change techniques are applied to segment a long movie into shorter video clips. After that, key frames are chosen from each video clip based on some low or medium level information, such as color, texture, or important objects in the scene. Later on, some higher-level semantic analysis can be applied to the segmented clips to group them into meaningful story units. When a customer wants to get a general idea of a certain movie, he can quickly browse the story units and if he is interested, he can dig into details by looking at key frames and each video clips.

Scalability is a very desirable option in streaming video application. The current streaming systems allow temporal scalability by dropping frames, and cut the wavelet bit-stream at a certain point to achieve spatial scalability. The present invention offers another scalability mode, which is called SNR and spatial scalability. This kind of scalability is very suitable for streaming video, since the videos are coded in base layer and enhancement layers. The server can decide to send different layers to different clients. If a client requires high quality videos, the server will send base layer stream and enhancement layer streams. Otherwise, when a client only wants medium quality videos, the server will just send the base layer to it. The video player is also able to decode scalable bit-stream according to the network traffic. Normally, the video player should display the video stream that the client asks for. However, when the network is really busy and the transmission speed is very slow, the client should notify the upstream server to only send the base layer bit-stream to relieve the network load.

After processing of the movie clips, scene change information and key frames are available, which can be used to popularize the movie database. Keywords, as well as visual content of key frames, can be used as indices to search for the movies of interest. Keywords can be assigned to movie clips by computer processing with human interaction. For example, the movies can be categorized into comedy, horror, scientific, history, music movies, and so on. The visual content of key frames, such as color, texture, and objects, should be extracted by automatic computer processing. Color and texture are relatively easy to deal with and the difficult task is how to extract objects from the natural scene. At present, the population process can be automatic or semi-automatic, where human operator may interfere.

After popularization, another embodiment of the present invention may allow customers to search for the movies they would like to watch. For example, they can specify the kind of movies, such as comedy, horror, or scientific movies. They can also choose to see a movie with certain characters they like, and so on. Basically, the intelligent retrieval capability allows them to find the movies they like in a much shorter time, which is very important for the customers.

Multicasting is an important feature of streaming video. It allows multiple users to share the limited network bandwidth. There are some scenarios that multicasting can be used with another embodiment of the present invention. The first case is a broadcasting program, where the same content is sent out at the same time to multiple customers. The second case is a pre-chosen program, where multiple customers may choose to watch the same program around the same time. The third case is when multiple customers order movies on demand, some of them happen to order the same movie around the same time. The last case may not happen frequently and another embodiment of the present invention shall focus on the first cases for the multicasting utilization. Basically, multicasting allows us to send one copy of encoded movie to a group of customers instead of sending one copy to each of them. It can greatly increase the server capability and make full use of network bandwidth.

Due to the combination of the present invention's DRFS technology and proprietary video compression performance, very high compression ratio can be achieved for high-quality content delivery. The following table gives an estimation of compression performance. (The estimation is based on frame size of 320×240 at 30 frames/sec.)

| 100-min | DVD quality | | VCD quality | | DAC quality | |
|---|---|---|---|---|---|---|
| Movie | (20:1) | | (40:1) | | (80:1) | |
| (Raw | | Down- | | Down- | | Down- |
| Data | Data | load | Data | load | Data | load |
| Size) | Size | Time | Size | Time | Size | Time |
| 19775 M | 989 M | 3956 Sec | 495 M | 1980 Sec | 248 M | 992 Sec |

Note:
2 Mbps channel bandwith is assumed.

TABLE 1
System Specifications

| Bandwidth | Server | Presentation | Server | Transfer Control | Transfer |
|---|---|---|---|---|---|
| (Client) | Capability | Delay | Network | Protocol | Protocol |
| 1.5 Mbps | 1.5 Gbps | 6 Minutes | Fiber/ATM | RTSP | RTP |

| Fast | Pause/ | | | Intelligent | High quality, | |
|---|---|---|---|---|---|---|
| Forward/ | Stop/ | | | Movie | smooth | |
| Backward | Play | Storyboard | Scalability | Retrieval | playback | Multicasting |
| Yes | Yes | Yes | Yes | Yes | Yes | Yes |

TABLE 2

| 100-min | DVD quality | | VCD quality | | DAC quality | |
|---|---|---|---|---|---|---|
| Movie | (20:1) | | (40:1) | | (80:1) | |
| (Raw | | Down- | | Down- | | Down- |
| Data | Data | load | Data | load | Data | load |
| Size) | Size | Time | Size | Time | Size | Time |
| 19775 M | 989 M | 3956 Sec | 495 M | 1980 Sec | 248 M | 992 Sec |

1. A method for providing enhanced features for streamed video content over a network comprising the steps of:
a) initializing a web server and a media server
b) providing a client player to the end user;
c) opening the streaming session;
d) streaming the coded video content bit steam between the media server and client player;
e) enabling the enhanced feature set to the end user for manipulation through the client player;
f) terminating the streaming session.

2. The method as defined in claim 1, wherein the video content has been encoded for compression using prior art H263 standards.

3. The method as defined in claim 1, wherein the audio content has been encoded for compression using prior art MP3 standards.

4. The method as defined in claim 1, wherein the video content has been pre-encoded deriving semantic content from the video to construct a searchable index of content features.

5. An apparatus for providing enhanced features for streamed video content over a network comprised of:
a web server and a media server
a client player offering an enhanced feature set to the end user;
means of initiating and maintaining and terminating a streaming session between the media server and client player.

6. The apparatus as defined in claim 1, wherein the video content has been encoded for compression using prior art H263 standards.

7. The apparatus as defined in claim 1, wherein the audio content has been encoded for compression using prior art MP3 standards.

8. The apparatus as defined in claim 1, wherein the video content has been pre-encoded deriving semantic content from the video to construct a searchable index of content features.
